(19) United States
(12) Patent Application Publication
(10) Pub. No.: US 2016/0302455 A1
(43) Pub. Date: Oct. 20, 2016

(54) Methods Of Producing An Antimicrobial Solution And Methods For Reducing Bacteria On Produce And/Or Minimizing Enzymatic Browning Of Produce

(71) Applicant: The United States of America, as represented by the Secretary of Agriculture, Washington, DC (US)

(72) Inventor: Dike O. Ukuku, Philadelphia, PA (US)

(21) Appl. No.: 14/685,980

(22) Filed: Apr. 14, 2015

(51) Int. Cl. A23L 3/358

(52) U.S. Cl. CPC A23L 3/358; A23V 2002/00

(57) ABSTRACT

Disclosed are methods of producing an antimicrobial solution, involving dissolving nisin in hydrochloric acid and adding an ionic chelator solution to form a base solution, heating the base solution, adding sodium lactate to the base solution, followed by adding sorbic acid to the base solution, heating the base solution, followed by adding hydrogen peroxide to the base solution, followed by adding citric acid to the base solution, followed by heating the base solution, followed by adjusting the pH of the base solution to about 5.0±0.2 with a base. Also disclosed are antimicrobial solutions and/or anti-browning solutions produced by the methods described herein. Furthermore, there are disclosed methods for reducing bacteria on produce and/or minimizing enzymatic browning of produce, involving contacting the produce with an effective bacterial reducing amount and/or an effective enzymatic browning minimizing amount of the antimicrobial solution described herein.

### BACKGROUND OF THE INVENTION

Disclosed are methods of producing antimicrobial solutions, involving dissolving nisin in hydrochloric acid and adding an ionic chelator solution to form a base solution, heating the base solution, adding sodium lactate to the base solution, followed by adding sorbic acid to the base solution, heating the base solution, followed by adding hydrogen peroxide to the base solution, followed by adding citric acid to the base solution, followed by heating the base solution, followed by adjusting the pH of the base solution to about 5.0±0.2 with a base. Also disclosed are antimicrobial solutions and/or anti-browning solutions produced by the methods described herein. Furthermore, there are disclosed methods for reducing bacteria on produce and/or minimizing enzymatic browning of produce, involving contacting the produce with an effective bacterial reducing amount and/or an effective enzymatic browning minimizing amount of the antimicrobial solution described herein.

Vegetables play a dominant role in the U.S. For example, about a quarter of California's agricultural crop Value comes from commercial vegetables ($6.3 billion, excluding potatoes) representing 51 percent of U.S. vegetable farm value. According to information available on the USDA Economic Research Service (ERS) California Drought Monitor page, the San Joaquin Valley produces one-third of California's vegetables which, in 2012, amounted to a district total of $2.55 billion in gross farm value (County Agricultural Commissioners' Reports, 2012). It is the second largest vegetable-producing district in California, next to the Central Coast Valley, which generated $3.36 billion in gross farm value in the same year. Ninety-two percent of harvested vegetable acreage in the Central Coast district is for the fresh market, according to USDA's 2012 Census of Agriculture, while those in the San Joaquin Valley are more equally divided between the fresh and processing markets (48 percent and 52 percent, respectively). In the United States, 31% of the 430 billion pounds of the available food supply at the retail and consumer levels in 2010 went uneaten. The estimated value of this food loss was $161.6 billion using retail prices. For the first time in 2010, ERS estimated the calories associated with food loss: 141 trillion, or 1,249 calories per capita per day.

Consumers are becoming more health conscious and tend to opt for food classified as natural or those with minimal or no heat treatment (Ukuku, D. O., et al,. J. Food, Agric and Environ., 11(3&4): 340-345 (2013); Ukuku, et al., J. Food Prot., 75:1912-1919 (2012). There are numerous reports of disease due to consumption of fruits and vegetables that were contaminated with enteric pathogens (Beuchat, L. R., J. Food Protection, 59: 204-216 (1995)). Pre- or post-harvest contamination most likely originates directly or indirectly from fecal matter. Contributing factors include use of uncomposted manure for fertilizing, irrigation with contaminated water, poor hygiene and unsanitary procedures by field and processing workers, inadequate cleaning and sanitizing of processing equipment, the use of decayed or damaged produce (e.g., melons), and failure to wash produce (e.g., melons) properly prior to packing or fresh-cut processing (Brackett, R. E., J. Food Protection, 55: 808-814 (1992); Ukuku, D. O., et al., J. Food Safety, 21: 31-47 (2001); Gagliardi, S. V., et al., J. Food Prot., 66: 82-87 (2003)). The surface of cantaloupe is covered by a well-developed, shallowly striated, waxy cuticle which varies in thickness but generally conforms closely to cellular outlines (Webster, B. D., and M. E. Craig, M. E., J. Am. Society for Horticultural Science, 101: 412 (1976)). Microstructure of the netting gives the cantaloupe rind inherent surface roughness likely to favor bacterial attachment (Ukuku, D. O., and W. F. Fett, J. Food Prot., 65:1093-1099 (2002a); Ukuku, D. O., and W. Fett, J. Food Prot., 69: 1835-1843 (2006)). The specific source of melon contamination is often unknown (FDA, Produce safety at retail: Safe handling practices for melons, Center for Food Safety and Applied Nutrition, 2001; FDA, Duck Deliver Produce recalls cut honeydew and cut cantaloupe melon for possible health risk, 2003). Transfer of Salmonella from the cantaloupe rind into the melon flesh by the physical act of cutting the cantaloupe or direct contact with contaminated rinds has been reported (Ukuku, D. O., and G. M. Sapers, J. Food Protection, 64: 1286-1291 (2001)).

Food producers and researchers are responding to consumers' demand for fresh safe food by proposing and developing non-thermal process intervention treatments that can keep food fresh or near fresh without altering the sensorial characteristic of the produce. The desire for health, or will-to-health continues to rage within US consumers; they will continue to make this demand for fresh or minimally processed produce. Washing is one of the very first processing operations to which a fruit or vegetable is subjected. Chlorination of wash water, up to 200 ppm, is routinely applied to reduce microbial contamination in produce processing lines (Wei, C-I., et al., Food Technology, 1: 107-115 (1995)). However, the use of chlorine is of concern due to the potential formation of harmful by-products (Richardson, S. D., et al., Food Technology, 52: 58-61 (1998)) and typically can only achieve a 1 to 2 log reduction of native microflora (Ukuku et al., 2001). Therefore, the safety of fresh and fresh-cut produce (e.g., melons) available in salad-bars and supermarkets is a concern (Hurst, W. C., and G. A. Schuler, J. Food Protection, 55: 824-827 (1992); Tamplin, M., Dairy Food Environ. Sani., 17: 284-286 (1997)).

There are several reports that nisin used in combination with a chelating agent, such as ethylenediaminetetraacetic acid (EDTA), exhibits a bactericidal effect towards both gram-positive and grain-negative bacteria (Stevens, K. A., et al., Appl. Environ. Microbiol., 57: 3613-3615(1991); Inter. Patent No. PCT/US89/02525; Cutter, C. N., and G. R. Siragusa, J. Food Prot., 58: 977-983 (1995); Stevens et al., 1991; Stevens, K. A., et al., Appl. & Environ. Microbial., 58: 1786-1788 (1992a); Stevens, K. A., et al., S. Food Prot., 55: 763-766 (1992b); Torriani, S., et al., J. Food Prot., 60: 1564-1567 (1997); Ukuku, D. O., and W. F. Fett, J. Food Safety, 22: 231-253 (2002b): Ukuku, D. O., and W. F. Fett, J. Food Protection, 67: 2143-2150 (2004)). Previously, we investigated the growth kinetics of Salmonella, E. coli O157:H7 and L. monocytogenes populations in apple cider amended with 300 IU nisin and the growth data were used to obtain the lag phase (LP), growth phase (GP), and the generation time (GT) (Ukuku, D. O., et al., Foodborne Pathogens and Disease, 6: 487-494 (2009)). Similarly, we investigated the effect of nisin, EDTA, sodium lactate, and potassium sorbate on Salmonella populations inoculated on cantaloupe rind surface (Ukuku and Fett, 2004). In all these studies, the authors noted variation in antimicrobial activity amongst media and bacteria for each acid tested. My current research has identified specific GRAS (generally regarded as safe) organic acids and the order to which there can be combined in nisin-EDTA solution to achieve a maximum bacterial inactivation, on produce.

Disclosed herein are novel antimicrobial sanitizing solutions containing short chain organic acids generally regarded as safe (GRAS) in nisin and ethylenediaminetetraacetic acid (EDTA) base solution for reducing the populations of human bacterial pathogens on produce surfaces and transfer to fresh-cut pieces during fresh-out preparation.

### SUMMARY OF THE INVENTION

Disclosed are methods of producing an antimicrobial solution, involving dissolving nisin in hydrochloric acid and adding an ionic chelator solution to form a base solution, heating the base solution, adding sodium lactate to the base solution, followed by adding sorbic acid to the base solution, heating the base solution, followed by adding hydrogen peroxide to the base solution, followed by adding citric acid to the base solution, followed by heating the base solution, followed by adjusting the pH of the base solution to about 5.0±0.2 with a base. Also disclosed are antimicrobial solutions and/or anti-browning solutions produced by the methods described herein. Furthermore, there are disclosed methods for reducing bacteria on produce and/or minimizing enzymatic browning of produce, involving contacting the produce with an effective bacterial reducing amount and/or an effective enzymatic browning minimizing amount of the antimicrobial solution described herein.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

FIG. 1 shows scanning electron microscopy observation of un-inoculated cantaloupe rind surface immediately after purchase from the distributor as described below. Arrows in A point to presence of natural bacteria, possible spores and debris while in B the T stands for Tricome, N=Netting, and E=Epidermis. Surface structure/characteristic of un-inoculated and untreated melon purchased from the distributor were evaluated using scanning electron microscopy to see where bacteria may hide.

FIG. 2 shows scanning electron microscopy observation of inoculated cantaloupe rind surface after inoculation and without treatment (A=whole surface, B=netting) as described below. Surface of melon purchased from the distributor were inoculated with bacteria at approximately 4.8 log CFU/cm². FIG. 2 shows where and how the inoculated bacteria attached to the melon surface

FIG. 3 shows scanning electron microscopy observation of inoculated cantaloupe rind surface after treatment with 200 ppm chlorine as described below. Surface of melon purchased from the distributor were inoculated with bacteria at approximately 4.8 log CFU/cm² and then washed with 200 ppm chlorine for 5 min. Bacterial populations on the whole surface was reduced while those inside the netting were minimally reduced.

FIG. 4 shows scanning electron microscopy observation of inoculated cantaloupe rind surface after treatment with 3% hydrogen peroxide as described below. Surface of melon purchased from the distributor were inoculated with bacteria at approximately 4.8 log CFU/cm² and then washed with 3% hydrogen peroxide for 5 min. Bacterial populations on the whole surface was significantly reduced while then morphology of those inside the netting were changed and total populations reduced was higher than chlorine treated melon.

FIG. 5 shows scanning electron microscopy observation of inoculated cantaloupe rind surface after treatment with Lovit sanitizer at room temperature as described below. Surface of melon purchased from the distributor were inoculated with bacteria at approximately 4.8 log CPU/cm² and then washed with Lovit sanitizer at room temperature for 5 min. Bacterial populations on the whole surface and those inside the netting were reduced significantly than chlorine and hydrogen peroxide treated melon.

FIG. 6 shows scanning electron microscopy observation of inoculated cantaloupe rind surface after treatment with Lovit sanitizer at 60° C. as described below. Surface of melon purchased from the distributor were inoculated with bacteria at approximately 4.8 log CFU/cm² and then washed with Lovit sanitizer at 60° C. temperature for 5 min showed a much better reduction of bacterial populations on the whole surface and those inside the netting than any other treated melon.

### DETAILED DESCRIPTION OF THE INVENTION

Disclosed are methods of producing an antimicrobial solution, involving dissolving nisin in hydrochloric acid and adding an ionic chelator solution to form a base solution, heating the base solution, adding sodium lactate to the base solution, followed by adding sorbic acid to the base solution, heating the base solution, followed by adding hydrogen peroxide to the base solution, followed by adding citric acid to the base solution, followed by heating the base solution, followed by adjusting the pH of the base solution to about 5.0±0.2 with a base. Also disclosed are antimicrobial solutions and/or anti-browning solutions produced by the methods described herein. Furthermore, there are disclosed methods for reducing bacteria on produce and/or minimizing enzymatic browning of produce, involving contacting the produce with an effective bacterial reducing amount and/or an effective enzymatic browning minimizing amount of the antimicrobial solution described herein.

This novel sanitizing solution consisting of a nisin, ethylenediaminetetraacetic acid (EDTA), sodium lactate, sorbic acid, hydrogen peroxide (H₂O₂) and citric acid, all compound generally regarded as safe (GRAS-compound) were generally prepared as follows: first, a 0.1 M disodium EDTA (Fisher Scientific Co., Pittsburgh, Pa.) was prepared by dissolving 37.2 g of EDTA in 1 L deionized water and then sterilized in autoclave at 121° C. for 15 min. A 30 mg of nisin (10⁶ I.U., Sigma, St. Louis, Mo.) was dissolved in 50 ml 0.02 N hydrochloric acid (HCl, pH 2) and then poured into 600-ml of the sterilized EDTA described above to generate the base solution. The base solution was placed on a hot plate with stirrer (Corning, USA) set at medium (5) speed and heat. After 5 min, a 99.99 ml sodium lactate (NaL, 60% w/w, Fisher Scientific) was added to the base solution, and was followed by 3.36 g of sorbic acid (Fisher Scientific Co., Pittsburgh, Pa.). Again, after 5 min of heating and stirring at medium heat, 200 ml hydrogen peroxide (H₂O₂, 30% w/w, Fisher Scientific) was added, and was followed by 5.76 g of citric acid (Fisher Scientific Co., Pittsburgh) in that order. The solution was brought to volume (3 L)in a 6 L flask. The flask was covered with aluminum foil to minimize light interference with mixed solution. The 6 L flask containing the sanitizer was left on the stirrer/heater for 4 h and then allowed to cool down to room temperature before use. The final pH of the sanitizer solution was adjusted to 5.0±0.2 with 10 N NaOH while heating and stirring on the Corning hot plate. This solution is called Lovit.

Disclosed herein are novel antimicrobial sanitizing solutions containing short chain organic acids generally regarded as safe (GRAS) in nisin and ethylenediaminetetraacetic acid (EDTA) base solution for reducing the populations of human bacterial pathogens on produce surfaces and transfer to fresh-cut pieces during fresh-cut preparation. The efficacy of this antimicrobial sanitizing solution in killing bacteria such as E. coil O157:H7, Salmonella spp. and L. monocytogenes populations inoculated on heat sensitive produce and on reducing transfer of these pathogens to fresh-cut pieces during fresh-cut preparation was investigated and the data obtained was compared to those from melons treated with chlorine and hydrogen peroxide washes.

Foods and beverages treated by the methods described herein include fruits and vegetables. Particularly included are apples, melons, apricots, peaches, pears, artichokes, beans, bell peppers, carrots, celery, tomato, lettuce, and spinach. Foods particularly include fresh-cut produce (e.g., fruits and vegetables) which is produce that has been, for example, peeled, cut, sliced, or shredded. The fresh-cut produce may be subsequently made into juice, or dried or dehydrated or frozen by methods known in the art.

Preferably the foods have been processed (i.e., are not in their natural state such as whole melons). Typically, fruits and vegetables are subjected to various processing techniques wherein they are subjected to disorganization of their natural structure, as by peeling, cutting, comminuting, pitting, pulping, freezing and dehydrating.

The antimicrobial solution also minimizes enzymatic browning of foods. The term “browning” as used herein generally refers to oxidative darkening or discoloration resulting from the formation of o-quinone and quinone polymers which result from the action of enzymes like polyphenol oxidase (PPO) in forming quinones or from the polymerization of quinones which occur naturally in some foods. The antimicrobial solution minimizes such browning. Minimizing of browning may be by preventing or inhibiting of browning. Browning is “prevented” if it is completely eliminated. Browning is “inhibited” if browning takes place at a significantly lower rate compared to untreated foods in the same time frame. To minimize (e.g., prevent or inhibit) browning the antimicrobial solution is used to treat the food in an amount and concentration sufficient to minimize (e.g., inhibit or prevent) browning. The form of treatment will depend upon the food being treated, and the results sought, and can include, e.g., dipping, spraying, sprinkling, immersing, mixing and/or soaking. The amount needed will depend upon the susceptibility of the food to browning, the condition of the food, and the storage conditions. The amount sufficient to minimize (e.g., prevent or inhibit) browning can be determined empirically by one skilled in the food art. For effective inhibition of browning reaction in fresh-cut pieces, the pH of Lovit solution is maintained at about 3 (e.g., 3) instead of 5.

Contacting or exposing foods (e.g., fresh-cut produce) with the antimicrobial solution described herein (to reduce bacteria and/or minimize browning) may occur by conventional methods such as spraying or dipping or immersion wherein the food (e.g., fresh-cut produce) is in contact with the antimicrobial solution for a certain period of time (e.g., about 120 seconds).

Unless defined otherwise, all technical and scientific terms used herein have the same meaning as commonly understood by one of ordinary skill in the art to which the invention belongs. As used herein, the term “about” refers to a quantity, level, value or amount that varies by as much as 30%, preferably by as much as 20%, and more preferably by as much as 10% to a reference quantity, level, value or amount. Although any methods and materials similar or equivalent to those described herein can be used in the practice or testing of the present invention, the preferred methods and materials are now described.

The following examples are intended only to further illustrate the invention and are not intended to limit the scope of the invention as defined by the claims.

### EXAMPLES

Specific organic acids, nisin EDTA and hydrogen peroxide and their concentrations used in making the sanitizer are shown in Table 1. Dark or amber bottles were used to house the sanitizer to minimize light interference of certain ingredient in the mix and the sanitizer solution was maintained at about pH 5 (e.g., pH 5).

Bacteria/Strains and Inoculum Preparation:

Bacterial strains used in this study were Escherichia coli O157:H7 strains SEA13B88, ATCC 25922 (type strain), and Oklahoma (apple juice cider-related outbreaks); Salmonella Stanley H0558 (alfalfa sprout-related outbreak, obtained from Dr. Patricia Griffin, CDC); Salmonella Poona RM2350, Salmonella Saphra 97A3312 (cantaloupe-related outbreaks, obtained from Ms. Sharon Abbott and Dr. Michael Janda, CA Dept. of Health Services); and L. monocytogenes P8027 (Serotype 4b) and F8385 (Serotype 1/2b) received from Dr. Larry Beuchat, Univ. of Georgia. Bacteria were maintained on Brain Heart Infusion Agar (BHIA, BBL/Difco, Sparks, Md.) slants held at 4° C. Prior to use, the cultures were subjected to two successive transfers by loop inocula to 10 ml Brain Heart Infusion Broth (BHIB, Difco) (Salmonella and E. coli) or 10 ml Trypticase Soy Broth supplemented with 0.6% yeast extract (TSBYE, BBL/Difco) (L. monocytogenes). A final transfer of individual strains at 0.2 ml was made into 20 ml BHI or TSBY with incubation at 36° C. for 18 h under static conditions. The bacterial cells were centrifuged at 10,000 g for 10 min at 4° C. and the cell pellets for L. monocytogenes, Salmonella spp., and E. coli O157:H7 were washed twice in 0.1% peptone water (PW, BBL/Difco) and subsequently combined and resuspended to prepare three different types of inoculum stated below. Bacterial inoculum for E. coil O157:H7, Salmonella spp., and L. monocytogenes consisted of a mixture containing strains of individual genera (3 strains/genus) listed above at 10 CFU/ml. All inocula were prepared in 3 L of 0.1% (w/v) PW and the final bacterial concentration in the inoculum suspension averaged 10⁷ CFU/ml, and was used to inoculate the whole cantaloupe melons.

Inoculation of Produce:

Unwaxed whole “Western shippers” cantaloupes (1745 g to 1778 g), honeydew (1698 g to 1774 g), and watermelons (1998 to 2068 g) were purchased from a local distributor and were placed on a bench top for 18-20 h to allowed them to come to room temperature (˜20° C.) before being inoculated. All bacterial inoculation on melon rind surface and decontaminations was performed inside a biosafety cabinet (Nuaire, Class II, Type A2, Plymouth, Minn.). Two melons per each category were submerged in 3 L of bacterial inoculum described above and agitated by stirring with a glove-covered hand for 5 min to ensure uniform inoculation. Melon inoculations described above were performed for each produce per bacterium and this procedure was repeated three times for each melon type. After inoculation, the melons were placed inside a biosafety cabinet to dry for 1 h and then were stored at 5° C. for up to 7 days before application of washing treatments and fresh-cut preparation. The initial number of colony forming units (CFU) on each produce were determined immediately after inoculation and storage.

Ingredients and Formulation of Lovit Sanitizing Solution:

This novel sanitizing solution contains several short chain organic acids generally regarded as safe in a nisin-ethylenediaminetetraacetic acid (EDTA) combination base solution. First, 30 mg of nisin (106 I.U., Sigma, St. Louis, Mo.) was dissolved in 50 ml 0.02 N hydrochloric acid (HCl, pH 2) and was poured into sterile 500 ml 0.1 M disodium EDTA (Fisher Scientific Co., Pittsburgh, Pa.) and then was placed on a hot plate/stirrer (Corning, US) set at medium (5) speed/heat. This becomes the base solution to which all GRAS compounds were added in this specific order: a 99.99 ml sodium lactate (NaL, 60% w/w, Fisher Scientific) was added to the base solution and was followed by addition of 3.36 g of sorbic acid (Fisher Scientific Co., Pittsburgh, Pa.), a 200 ml hydrogen peroxide (H₂O₂, 30% w/w, Fisher Scientific) was added, followed by 5.76 g of citric acid (Fisher Scientific Co., Pittsburgh) in that order (Table 1). The solution was brought to volume (3 L) in a 6 L flask and the entire flask containing the sanitizer solution was covered with aluminum foil to provide darkness. The 6 L flask containing the sanitizer was left on the stirrer/heater for 4 h before use. The final pH of the sanitizer solution was adjusted to 5.0±0.2 with p10 N NaOH and the solution was named Lovit. The Lovit solution produced by this process surprisingly achieved a maximum bacterial inactivation compared to when the process of preparation listed in Table 1 was reversed, and the solution left uncovered with aluminum foil room temperature before use.

Other washing solutions tested were sterilized tap water 200 ppm chlorine, and 3% hydrogen peroxide. The 200 ppm chlorine solution was prepared by diluting Clorox® commercial bleach containing 5.25% NaOCl in sterile deionized water and adjusting the pH to 0.1 by adding citric acid (Mallinckrodt, Paris, Ky.). A 3% hydrogen peroxide solution was prepared from a 30% stock solution (Fisher Scientific, Suwanee, Ga.) by dilution with sterile to water. Free chlorine in the solution was determined with a chlorine test kit (Hach Co., Ames, Iowa) that has been approved by the U.S. Environmental Protection Agency.

Washing Treatments:

Inoculated melons described above were washed in 3 liters of sterilized tap water, 200 ppm chlorine wash-water, 3% hydrogen peroxide, or the nisin-based sanitizer solutions (Lovit) stated above for 5 min. All washing treatments were performed inside a biosafety cabinet by dipping melons inside the solutions with constant agitation and rotation with a glove-covered hand to allow total coverage of solutions on melon surface. Washing treatments and fresh-cut preparations were performed at day 0 and 7 following inoculation and storage at 5° C. All melons ere placed inside a biosafety cabinet at ambient temperature to dry before fresh-cut preparation. The washing treatment solutions were frequently prepared after 2-3 washes to minimize the effect of organic load on the efficacy of the sanitizers. Fresh-cut pieces from un-inoculated and inoculated untreated produce similarly stored were used as the controls.

Scanning Electron Microscopy:

The cantaloupe melons were sampled before and after inoculation following treatments described above. After inoculation and treatments, a sterilized stainless steel cork-borer was used to cut through whole melon surfaces at random locations to produce ring plugs 22 mm in diameter with a rind surface area of 3.80 cm² and the adhering flesh tissue was removed with a knife. The rind plugs were placed into petri dishes lined with sterile filter paper. Duplicate samples were initially fixed in glutaraldehyde vapor to avoid washing off dried layers of inoculum on the rind surface, followed by immersion fixation in 2.5% glutaraldehyde-0.1 M imidazole buffer solution (pH=7.0) for 2 h and stored in sealed bottles at RT until further processing. The fixed samples were then washed in the buffer, dehydrated in a graded series of ethanol (50%, 80%, then absolute), and critical-point dried from liquid carbon dioxide. The plugs were mounted onto specimen stubs using Duco cement (Devcon, Riviera Beach, Fla.) and coated with a thin layer of gold by direct current sputtering. Digital images were collected in the secondary electron-imaging mode of a scanning electron microscope (SEM) Model Quanta 200 (FEI, Hillsboro, Oreg.).

Microbial Analysis:

A sterilized stainless steel cork-borer was used to cut through whole melon surfaces at random locations to produce rind plugs 22 mm in diameter with a rind surface area of 3.80 cm². Flesh adhering to the rind plugs was trimmed off using a sterilized stainless steel knife. Plugs (n=40) per melon rind surfaces, carefully trimmed by removing inner flesh, and weighing approximately 25 g total were blended (Waring commercial blender, speed level 5, 1 min) in 75 ml of 0.1% peptone-water. Colony forming units (CFU) for all bacterial populations were determined by plaiting 0.1 ml of homogenized samples on different agar (selective and non-selective) plates. Plate Count Agar (PCA) with incubation at 30° C. for 72 h was used for enumeration of mesophilic aerobic bacteria. Pseudomonas spp were enumerated by plating 0.1 ml on Pseudomonas isolation agar (Difco/BBL) with incubation at 27° C. for 3 days. Czapek Malt Agar (CMA) with incubation at 30° C. for 72 h was used for yeast and mold (Messer, P. M., et al., Aerobic Plate Count, IN FDA Bacteriological Analytical Manual., 6^{th} ed., 1984, pp. 4.01-4.10). For Salmonella, Xylose Lysine Sodium Tetradecylsulfate (XLT4, BBL/Difco, Sparks, Md.) agar with incubation at 37° C. for 24 h was used to count the CPU (Ukuku and Sapers, 2001). For comparison, a pure culture of Salmonella plated on XLT4 agar (Difco), incubated as above, and run parallel with the samples was used. Selected colonies from the agar plates were confirmed to be Salmonella according to the FDA Bacteriological Analytical Manual following conventional biochemical methods (Andrews, W. H., et al., Salmonella, p. 5.01-5.19, IN: FDA Bacteriological Analytical Manual, 8th ed., Association of Official Analytical Chemists, 1995, Gaithersburg, Md.) as well as serological assays using latex agglutination (Oxoid, Ogdensburg, N.Y.), Bacterial count for E. coli O157:H7 was performed on Cefixame Tellurite Sorbitol MacConkey agar (CT-SMAC, BBL/Difco) with incubation at 37° C. for 24 h/ Selected colonies were confirmed to be E. coli O157:H7 as described by Hitchins et al. (Hitchins A. D., et al., E. coli and the Coliform Bacteria, IN: FDA Bacteriological Analytical Manual, 8th ed., Chapter 4, Association of Official Analytical Chemists, 1995, Gaithersburg, Md). For L. monocytogenes, Modified Oxford Agar (MOX, Difco) and Listeria identification agar (PALCAM, Sigma, MO) containing Listeria selective supplement (L-4660, Sigma) were used with incubation at 37° C. for 48 h (Lovett, J., and A. D. Hitchins, Listeria isolation, Bacteriological Analytical Manual (BAM), FDA, Chapter 29, (Revised Oct. 13, 1988), Supplement to 6th edition, Assoc. Offic. Anal. Chem., VA). All plating was done in duplicate. In addition, pure cultures of L. monocytogenes were surface plated onto MOX and PALCAM agars to serve as references for identification. Representative presumptive colonies of L. monocytogenes were subjected to analysis by use of API Listeria test kits (bioMeriux Marcy l'Etiole, France) for confirmation.

Bacterial inactivation in all media tested was calculated using this formula [I]:

Log [No/N]

where No=count of bacteria before treatment (control), N=count of bacteria in treated samples.
In a preliminary experiment to test the efficacy of the prepared antimicrobial solution to vivo 0.1 ml of each class of bacterium prepared above was inoculated into 9.9 ml of sterilized tap water, 200 ppm chlorine, 3% H₂O₂, or Lovit sanitizer and the surviving populations of each pathogen including percent injured cells were determined immediately and after 1, 2, 3, 4, 5 and 24 h of storage at room temperature for 24 h.

Percent injury for bacteria cells as a function of treatments where appropriate was calculated using this formula [2]:

[1−[((colonies on selective agar))/((counts on nonselective agar))]×100.

Fresh-Cut Melons:

To prepare fresh-cut pieces, whole melons were cut into four sections using a sterile knife and the rinds were carefully removed. The interior flesh was cut into ˜3 cm cubes and fresh-cut pieces were investigated for the presence of transferred E. coli O157:H7, Salmonella, or L. monocytogenes. Approximately 100 g of the flesh were placed in a Stomacher® bag with 200 ml of 0.1% peptone water and pummeled for 30 s in a Stomacher (model 400; Dynatech Laboratories, Alexandria, Va.) at medium speed. Samples (1 ml) were pour plated using either TC-SMAC or PALCAM containing Listeria selective supplement and plates were incubated at 36° C. for 24 h (Lovett and Hitchins, 1988). In a separate experiment where no colonies were determined on the plates, fresh-cut pieces (˜100 g) were placed in a Stomacher® bag with 200 ml of University of Vermont (UVM) broth (BBL/Difco) followed by incubation at 36° C. for 24 h to see if bacteria can be determined by enrichment procedure. A 1ml portion of the UVM broth culture was added to 9 ml of Fraser broth (BBL/Difco) and incubated at 35° C. for 24 h. An A.O.A.C. approved Listeria Rapid Test (Oxoid, Ogdensburg, N.Y.) was used to test for the presence of L. monocytogenes in the broth culture. For E. coli O157:H7, 200 ml of tryptic soya broth (TSB; BBL/Difco) was added to the same amount of fresh-cut melon in a stomacher bag. After incubation at 36° C. for 6 h, 0.1 ml portions of the homogenates was plated on TC-SMAC and plates were incubated at 36° C. for 24 h. Selected colonies were confirmed as E. coli as described by Hitchins et al. (1995).

Data Analysis:

All experiments were done in triplicate with duplicate samples analyzed at each sampling time. Microbial data determined from agar plates were converted to log 10 CFU/cm² or log 10 CUF/g) where appropriate. Data were subjected to the Statistical Analysis System (SAS Institute, Cary, N.C.) for analysis of variance (ANOVA). Mean values of bacterial cell numbers on treated and untreated cantaloupe were compared to determine significant differences at (p<0.05) using the Bonferroni LSD method (Miller, R. G., Jr., Simultaneous Statistical inference, 2nd edition, 1981, pp. 67-70, Springer-Verlag, New York).

Results and Discussion.

Effect of Lovit, 200 ppm Chlorine, and Hydrogen Peroxide Treatments on Bacterial Cells:

The populations of the surviving bacteria and the efficacy of all treatments in samples stored at room temperature (22° C.) for 24 h is shown in Table 2. The average populations of human bacterial pathogens inactivated in 200 ppm chlorine, 3% H₂O₂, or Lovit-sanitizer within 30 min of inoculation was 4.7, 5.0 and 6.3 log for L. monocytogenes, 5.4, 5.5 and 6.0 log for E. coli O157:H7, and 4.8, 5.1 and 6.1 log for Salmonella respectively. Surprisingly bacterial inactivation by Lovit was significantly (p<0.05) different than chlorine and H₂O₃ and this trend was again observed in 24 h samples. Due to the surprisingly total inactivation of resting cells of Salmonella spp., L. monocytogenes, and E. coli O157:H7 bacteria by Lovit treatment, the study was extended to investigate how it can be used to reduce populations of bacteria on cantaloupe, watermelon, and honeydew rind surfaces and transfer to fresh-cut pieces during preparation.

Activity of Lovit Treatments on Native Microflora of Melons:

Efficacy of individual GRAS organic acids used and its combination on microbial reduction on cantaloupe rind surfaces is shown in Table 3 (HP+Nal+SA+Ca+EDTA+Nisin, the last combination in the table is Lovit). Microbial inactivation on cantaloupe surfaces varied per each organic acid. However, surprisingly Lovit sanitizer containing HP+Nal+SA+CA+EDTA+Nisin combination was very effective in reducing bacterial populations on cantaloupe rind surfaces, and the populations for all pathogens tested for were significantly (p<0.05) different than individual acids and other combinations. Most of the data presented in Table 3 came from cantaloupe rind surface study as it was the most difficult surface to detach inoculated and attached pathogens (Ukuku et al., 2001; Ukuku and Fett, 2002a; Ukuku, D. O., and W. F. Fett, J. Food Protection, 65: 924-930 (2002c)).

The efficacy of the treatments was extended to investigate survival of native bacterial population on cantaloupe rind surfaces. The average population of native microflora of cantaloupe rind surfaces was 5.7 log CFU/cm², yeast and mold population was 3.0 log CFU/cm², Pseudomonas spp was 2.4 log CFU/cm², and 3.0 log CFU/cm² for lactic acid bacteria, respectively (Table 4). All of the classes of bacteria tested for were transferred to fresh-cut pieces during fresh-cut preparation using untreated whole cantaloupe. On treated whole cantaloupe rinds, bacterial transfers to fresh-cut pieces were significantly reduced by all treatments with significant (p>0.05) level of inactivation being surprisingly higher in fresh-cut pieces from Lovit treated cantaloupes. Most of the flesh-cut pieces were below detection for yeast and mold, Pseudomonas spp and lactic acid bacteria. A similar observation was seen on watermelon rind surfaces and fresh-cut pieces (Table 5) and honeydew melon pieces (Table 6); although both chlorine and 3% H₂O₂ were equally effective in reducing bacterial population on the rind surface and transfer to fresh-cut pieces. Only the control fresh cut pieces showed presence of all classes of native bacteria investigated. Microbial inactivation on melon surfaces varied per each treatment and the type of melon tested. It would be noted that cantaloupe rind surfaces compared to other melons tested had higher microbial populations due to the netted venation as opposed to the smooth surfaces of watermelon and honeydew rind surfaces.

Effect of Sanitizing Processing on Population Reduction of Human Bacterial Pathogens:

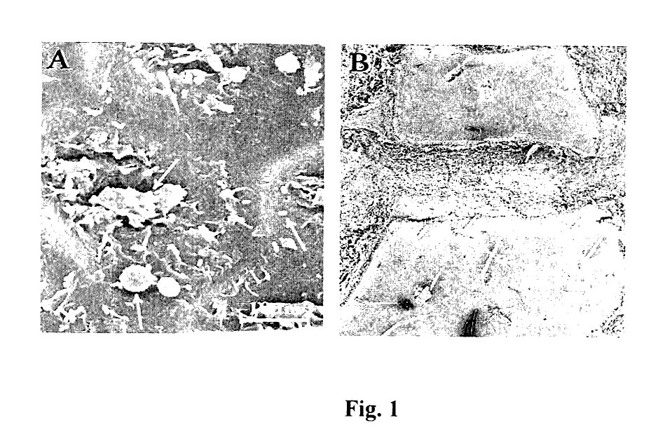

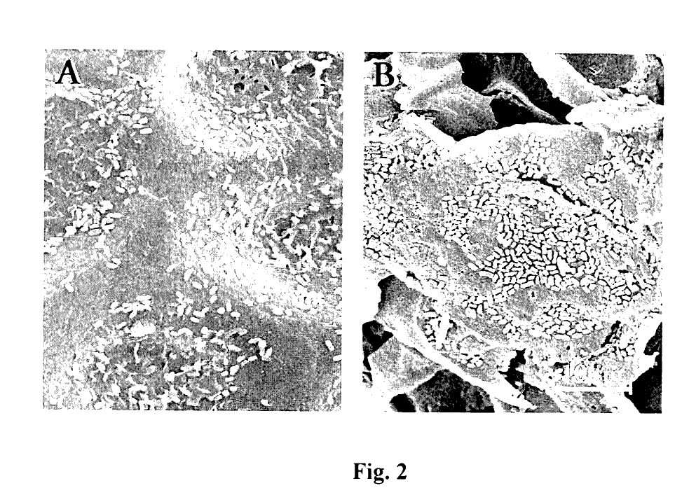

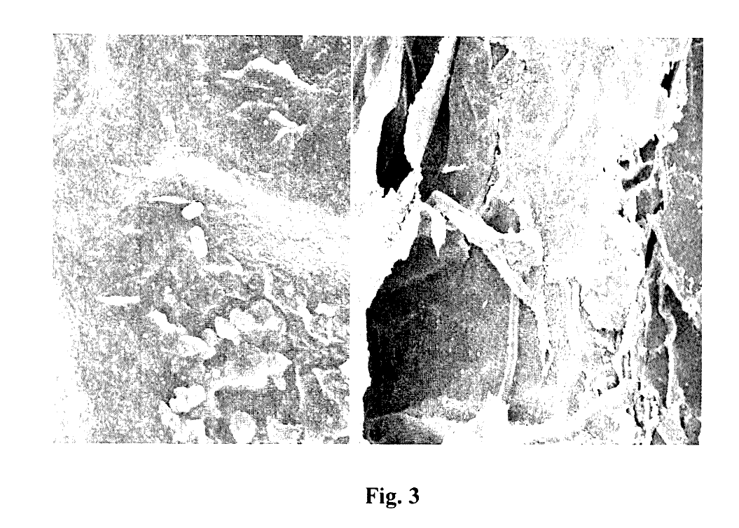

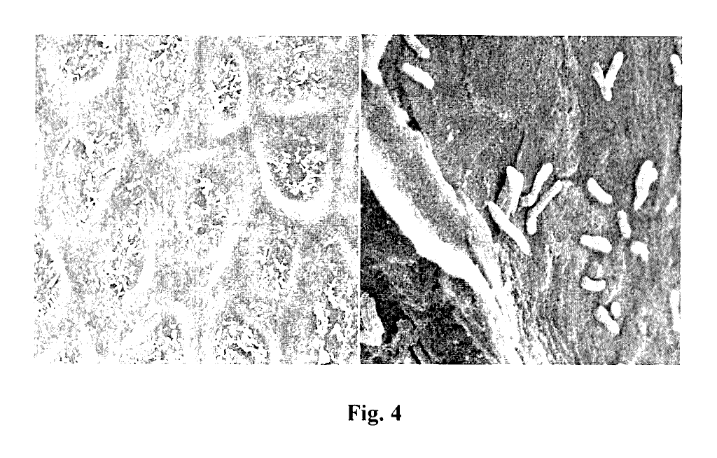

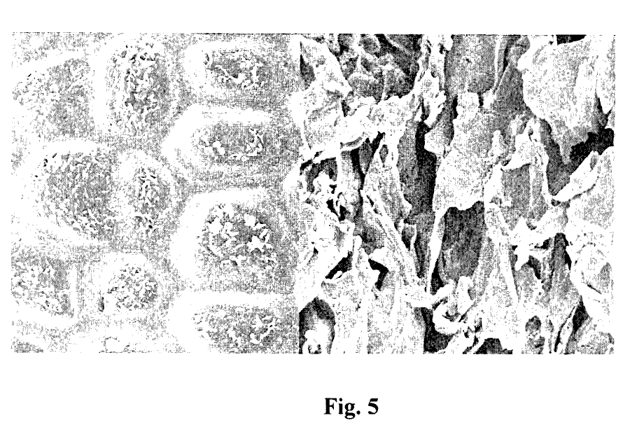

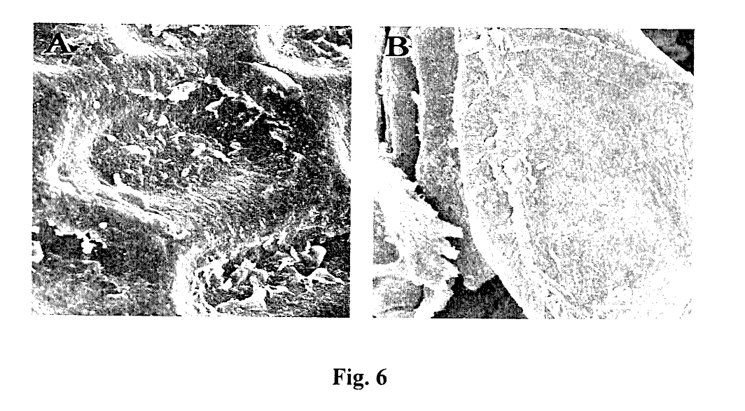

The efficacy of all sanitizing treatments on the surviving populations of all bacterial pathogens tested on melon rind surfaces and subsequent transfer to fresh-cut pieces is shown in Table 7. Attachment of human bacterial pathogens on the melon rind surfaces varied and so does the surviving populations determined after treatments. Surprisingly, viability loss for all pathogens as a function of treatment using Lovit sanitizer was significantly (p<0.05) different than chlorine and hydrogen peroxide. In most watermelon, honeydew, and cantaloupe rind surfaces tested, the surviving populations were surprisingly below detection on Lovit treated melons compared to chlorine and hydrogen peroxide (SEM, FIGS. 1-6). The SEM observations and plate count determinations of colony forming units on contaminated cantaloupe rind surface both confirmed that Lovit treatment was surprisingly a better sanitizer in reducing microbial populations than chlorine or hydrogen peroxide treatment. The efficacy of Lovit sanitizer prepared in reverse order as stated above and without covering with aluminum foil to provide protection against light was also tested. Viability loss for microbial population on treated melons surfaces surprisingly were slightly lower than those prepared by covering the bottles. Similarly storing Lovit at room temperature (20° C.) for 7 days and at refrigeration temperature (5° C.) Or similar number of days did not show significant (p<0.05) difference in population reduction (data not shown).

Efficacy of Lovit treatment in reducing microbial population on melon rind surfaces was found to be dependent on the type of melon, pH, container used in preparing the solution, and agitation during treatment and also order of adding the organic acids. For example, microbial reduction was highest for watermelon followed by honeydew and cantaloupes. Similarly, Lovit pH at 5 achieved the maximum bacterial kill while bacterial populations reduced on melons treated with Lovit covered with aluminum foil was slightly higher than non-covered flask but the numbers were not significantly different. Also, highest microbial reduction was observed on melons dipped in sanitizer solution with continuous rubbing (of the melon surface with glove covered hand).

Use of chemical or physical antimicrobial treatments to sanitize whole melons before shipment and fresh-cut preparation may be desirable (Ukuku et al., 2001). However, the recontamination of the sanitized whole melons rind with L. monocytogenes or E. coli O157:H7 because of poor plant sanitation or use of improper handling or packaging procedures as reported by Ukuku and Fett (2002b, 2002c) would still pose food safety concerns. Other researchers also reported surface irregularities such as roughness, crevices, and pits to increase bacterial adherence and reduce the ability of washing treatments to remove bacterial cells (ICMS (international commission on microbiological specifications for foods). Factors affecting life and death of microorganisms, IN: Microbial Ecology of Foods (1), 1980, Academic Press, New York). Effect of lactate on inhibiting and reducing microbial populations has been reported (Shelef, L. A., and Q. Yang, J. Food Protection, 54: 283-287 (1991); Shelef, L. A., J. Food Protection, 57: 445-450 (1994). Other researchers have documented the efficacy of nisin in killing L. monocytogenes, a Gram positive bacterium when used alone (Harris, L. J., J. Food Prot., 54: 836-840 (1991); Ukuku and Shelef, 1997; Cutter and Siragusa, 1995). H₂O₂ at 3% is available at any local pharmacy and can be used by consumers to wash cantaloupes in their kitchen prior to fresh-cut preparation in order to enhance the microbial safety of the fresh-cut pieces (Ukuku, D. O., et al., J. Food Prot., 75 (11): 1912-1919 (2012)). Although chlorine or hydrogen peroxide treatments significantly reduced populations of bacteria attached on cantaloupe surfaces (Ukuku et al., 2001; Ukuku, D. O., Food Microbiol., 23: 289-293 (2005), the level of decontamination achieved was not sufficient to assure microbiological safety. Other studies on the efficacy of chlorine treatment of fresh produce reported incomplete removal or inactivation of bacteria (Beuchat, 1995; Brackett, 1992). The results of the Lovit study described herein showed that its efficacy in reducing microbial populations on produce surfaces was surprisingly better than chlorine or hydrogen peroxide treatment, suggesting that the use of Lovit sanitizer on melon surfaces designated for fresh-cut preparation would lead to microbial reduction, reduce the incidence of foodborne illness associated with contaminated melons, boost consumers confidence, and finally would reduce costly recall to save the produce industry billions of dollars.

All of the references cited herein, including U.S. Patents, are incorporated by reference in their entirety. Also incorporated by reference in their entirety are the following references: Ukuku, D. O., and L. A. Shelef, J. Food Prot., 60: 867-869 (1997); Ukuku, D. O., et al., J. Food Safety, 24: 129-146 (2004); Ukuku, D. O., and L. A. Shelef, J. Food Prot., 60: 867-869 (1997); Ukuku, D. O., International J. Food Microbiology 95, 137-146 (2004).

Thus, in view of the above, there is described (in part) the following:

A method for minimizing (or fully or partially preventing or inhibiting) browning (e.g., enzymatic) of foods susceptible to such browning, said method comprising (or consisting essentially of or consisting of) contacting said foods with an effective browning (e.g., enzymatic) minimizing or fully or partially preventing or inhibiting) amount of the antimicrobial solution described herein. A method of producing an antimicrobial solution, said method comprising (or consisting essentially of or consisting of) dissolving nisin in hydrochloric acid and adding an ionic chelator solution to form a base solution, heating said base solution for about 5 min (e.g., at about 25° C.), adding sodium lactate to said base solution, followed by adding sorbic acid to said base solution, heating said base solution for about 5 min (e.g., at about 62° C.), followed by adding hydrogen peroxide to said base solution, followed by adding citric acid to said base solution, followed by heating said base solution for about 4 hours at a temperature of about 99° C., followed by adjusting the pH of said base solution to about 5.0±0.2 with a base. The above method, wherein the container containing said base solution does not allow in light. The above method, wherein said method comprises dissolving nisin in hydrochloric acid and adding an ionic chelator solution to form a base solution, heating said base solution for about 5 acid min, adding sodium lactate to said base solution, followed, by adding sorbic acid to said base solution, heating said base solution for about 5 min, followed by adding hydrogen peroxide to said base solution, followed by adding citric acid to said base solution, followed by heating said base solution for about 4 hours at a temperature of about 99° C., followed by adjusting the pH of said base solution to about 5.0±0.2 with a base. The above method, wherein said method comprises dissolving nisin in hydrochloric acid and adding an ionic chelator solution to form a base solution, heating said base solution for about 5 min at about 25° C., adding sodium lactate to said base solution, followed by adding sorbic acid to said base solution, heating said base solution for about 5 min at about 62° C., followed by adding hydrogen peroxide to said base solution, followed by adding citric acid to said base solution, followed by heating said base solution for about 4 hours at a temperature of about 99° C., followed by adjusting the pH of said base solution to about 5.0±02 with a base. The above method, wherein said base is NaOH. The above method, wherein said ionic chelator solution is an ethylenediaminetetraacetic acid solution. The above method, wherein said ionic chelator solution is a disodium ethylenediaminetetraacetic acid solution.

An antimicrobial solution and/or anti-browning solution produced by the above method.

A method for reducing bacteria on produce and/or minimizing enzymatic browning of produce, said method comprising (or consisting essentially of or consisting of) contacting said produce with an effective bacterial reducing amount and/or an effective enzymatic browning minimizing amount of the above antimicrobial solution.

Foods or beverages (e.g., susceptible to browning) treated by the above method.

A method for reducing bacteria on produce, said method comprising (or consisting essentially of or consisting of) contacting said produce with an effective bacterial reducing amount of the above antimicrobial solution.

A method for minimizing enzymatic browning of produce, said method comprising (or consisting essentially of or consisting of) contacting said produce with an effective enzymatic browning minimizing amount of the above antimicrobial solution.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

TABLE 1
Ingredients used and their final concentrations

| | Amount | | | |
|---|---|---|---|---|
| | (g, mg or | | | |
| | volume) | | | |
| Ingredients | used | | Final conc. | |
| Nisin | 30 | mg | 0.01 | mg/mL |
| EDTA (dibasic) | 22.32 | g | 20 | nM |
| Sodium Lactate (60% NaL) | 99.99 | ml | 2% | |
| Density = 1.33, mwt. = 112.06 | | | | |
| Hydrogen peroxide (38%) | 200 | ml | 2% | |
| Density = 1.45, mwt. = 34.015 | | | | |
| Sorbic acid | 3.36 | g | 10 | mM |
| Mwt. = 112.127 | | | | |
| Citric acid | 5.76 | g | 10 | mM |
| Mwt. = 192.124 | | | | |

NOTE:
The Sanitizer solution was adjusted to pH 5 and boiled on a hot plate for 4 h

TABLE 2
In vivo survival of Salmonella spp, Escherichia coli O157:H7
and Listeria monocytogenes in water, 200 ppm chlorine and
Lovit sanitizer

| | Time | | | | |
|---|---|---|---|---|---|
| Bacteria | (h) | H₂O | 200 ppm Cl₂ | 3% H₂O₂ | Lovit |
| L. | 0 | 8.6 ± 0.2^{A} | | | |
| monocytogenes | 0.5 | 8.5 ± 0.1^{A} | 3.9 ± 0.2^{B} | 3.6 ± 0.2^{B} | 2.3 ± 0.2^{B} |
| | 1 | 8.5 ± 0.1^{A} | 3.3 ± 0.1^{C} | 3.2 ± 0.1^{C} | 1.7 ± 0.1^{C} |
| | 2 | 8.4 ± 0.2^{A} | 2.8 ± 0.2^{D} | 2.9 ± 0.2^{D} | 1.1 ± 0.2^{D} |
| | 24 | 8.3 ± 0.3^{A} | 2.6 ± 0.2^{D} | 2.8 ± 0.2^{D} | ND* |
| E. coli | 0 | 8.9 ± 0.4^{A} | | | |
| O157:H7 | 0.5 | 8.7 ± 0.4^{A} | 3.5 ± 0.2^{B} | 3.4 ± 0.2^{B} | 2.9 ± 0.2^{B} |
| | 1 | 8.5 ± 0.2^{A} | 3.4 ± 0.2^{B} | 3.3 ± 0.1^{B} | 3.0 ± 0.1^{B} |
| | 2 | 8.6 ± 0.1^{A} | 2.9 ± 0.1^{C} | 2.8 ± 0.2^{C} | 0.9 ± 0.2^{C} |
| | 24 | 8.6 ± 0.1^{A} | 2.7 ± 0.1^{C} | 2.7 ± 0.2^{C} | ND* |
| Salmonella | 0 | 8.4 ± 0.2^{A} | | | |
| spp. | 0.5 | 8.4 ± 0.1^{A} | 3.6 ± 0.2^{B} | 3.3 ± 0.2^{B} | 2.3 ± 0.2^{B} |
| | 1 | 8.3 ± 0.1^{A} | 3.4 ± 0.2^{B} | 3.3 ± 0.1^{B} | 2.0 ± 0.1^{B} |
| | 2 | 8.1 ± 0.2^{A} | 3.0 ± 0.1^{C} | 2.6 ± 0.1^{C} | 0.7 ± 0.2^{C} |
| | 24 | 8.0 ± 0.2^{A} | 2.4 ± 0.1^{D} | 2.6 ± 0.2^{C} | ND* |

^{a}Values represent means ± SD from three experiments with duplicate determinations per experiment. Means in the same column not followed by the same letter are significantly (p < 0.05) different.
ND* = No cells determined
Water (H₂O), Chorine (Cl₂), Hydrogen peroxide (H₂O₂)

TABLE 3
Bacterial reduction on cantaloupe rind surfaces using individual
organic acids and their combination known as Lovit sanitizer

| | | Yeast and | | Salmonella | E. coli |
|---|---|---|---|---|---|
| Agent (s) | Aerobes | mold | L. monocytogenes | spp | O157:H7 |
| Control | 5.7 ± 0.48 | 2.7 ± 0.22 | 4.2 ± 0.18 | 4.7 ± 0.22 | 5.4 ± 0.14 |
| Nisin (30 mg; (~10 μg/ml) | (1.2) | (0.9) | (3.6) | (—) | (—) |
| EDTA (0.02 M) | (0.4) | (0.3) | (0.2) | (0.4) | (0.3) |
| Nisin-EDTA | (2.3) | (1.7) | (3.8) | (3.6) | (3.3) |
| Citric Acid (10 mM) | (1.2) | (0.8) | (2.0) | (1.8) | (1.5) |
| CA + EDTA + Nisin | (2.4) | (2.0) | (3.9) | (3.4) | (3.3) |
| Sorbic acid (0.03%) | (1.1) | (2.3) | (2.2) | (2.0) | (1.8) |
| SA + CA + EDTA + Nisin | (2.7) | (2.5) | (3.8) | (3.5) | (3.8) |
| Sodium Lactate (2%) | (1.1) | (1.5) | (2.8) | (1.5) | (1.4) |
| Nal + SA + CA + EDTA + Nisin | (2.8) | (2.6) | (3.9) | (3.9) | (3.8) |
| Hydrogen peroxide (3%) | (2.0) | (2.6) | (3.4) | (3.0) | (2.9) |
| HP + Nal + SA + CA + EDTA + Nisin | (3.4) | (2.6) | (4.0) | (4.3) | (4.8) |

CA = Citric acid;
SA = Sorbic acid;
NaL = Sodium Lactate;
HP = Hydrogen peroxide.
Numbers with means ± SD represent initial populations of bacteria on cantaloupe rind surfaces and inoculated bacteria) pathogens before sanitizer treatments.
Numbers in parenthesis represents log reduction of each class of organism on cantaloupe rind surface after treatments, (—) = no change

TABLE 4
Transfer of aerobic mesophilic bacteria, yeast and mold and Pseudomonas spp. on
cantaloupe rind surfaces after Lovit treatment

| | Population (Log₁₀ CPU/cm²) for whole surface | | | | | | |
|---|---|---|---|---|---|---|---|
| | and (Log₁₀ CFU/g) for fresh-cut^{a} | | | | | | |
| | | | | | Hydrogen | | |
| | Control | | Chlorine (200 ppm) | | peroxide (3%) | | |
| | Whole | | Whole | | Whole | | Who [symbol] |
| Microflora | surface | Fresh-cut | surface | Fresh-cut | surface | Fresh-cut | surf [symbol] |
| Aerobic, mesophilic bacteria | 5.7 ± 0.2A | 2.5 ± 0.10B | 2.9 ± 0.2B | 1.9 ± 0.02C | 3.1 ± 0.13B | 1.9 ± 0.10C | 2.2 ± [symbol] |
| Yeast and mold | 3.0 ± 0.10A | 1.3 ± 0.02B | 1.1 ± 0.05B | BD | 0.9 ± 0.02C | BD | 0.3 ± [symbol] |
| Pseudomonas spp. | 2.4 ± 0.3A | 1.3 ± 0.07B | 0.8 ± 0.02C | BD | 0.6 ± 0.06C | BD | BD |
| Lactic acid bacteria | 3.0 ± 0.4A | 1.4 ± 0.02B | 0.5 ± 0.02C | BD | 0.8 ± 0.04C | BD | 0.4 ± [symbol] |

^{a}Values represent means ± SD for data from three experiments with duplicate determinations per experiment.
Means in the same row for each class of organism whole surface or fresh-cut melon not followed by the same letter are significantly (p < 0.05) different.
BD = Below detection (<1 CFU/g) [symbol]
indicates data missing or illegible when filed

TABLE 5
Survival and transfer of aerobic mesophilic bacteria, yeast and mold and
Pseudomonas spp. on watermelon rind surfaces after treatment

| | Population (Log₁₀ CPU/cm²) for whole surface and | | | | | |
|---|---|---|---|---|---|---|
| | (Log₁₀ CFU/g) for fresh-c [symbol] | | | | | |
| | | | | | Hydrogen | |
| | Control | | Chlorine (200 ppm) | | peroxide (3%) | |
| | Whole | | Whole | | Whole | |
| Microflora | surface | Fresh-cut | surface | Fresh-cut | surface | Fresh-cut |
| Aerobic mesophilic bacteria | 4.6 ± 0.2A | 1.8 ± 0.10B | 2.0 ± 0.2B | 0.8 ± 0.02C | 1.9 ± 0.12B | 0.5 ± 0.10D |
| Yeast and mold | 1.4 ± 0.1A | 0.6 ± 0.02B | BD | BD | BD | BD |
| Pseudomonas spp. | 1.9 ± 0.3A | 0.4 ± 0.07B | BD | BD | BD | BD |
| Lactic acid bacteria | 2.0 ± 0.4A | 0.6 ± 0.02B | BD | BD | BD | BD |

^{a}Values represent means ± SD for data from three experiments with duplicate determinations per experiment.
Means in the same row for each class of organism on whole surface or fresh-cut melon and those after treatments not followed by the same letter are significantly (p < 0.05) different.
BD = Below detection (<1 CFU/g) [symbol]
indicates data missing or illegible when filed

TABLE 6
Survival and transfer of aerobic mesophilic bacteria, yeast and mold and Pseudomonas
spp. on honeydew rind surfaces after treatments and fresh-cut preparation

| | Population (Log₁₀ CFU/cm²) for whole surface and (Log₁₀ CFU/g) for fresh- [symbol] | | | | | |
|---|---|---|---|---|---|---|
| | Control | | Chlorine (200 ppm) | | Hydrogen peroxide (3%) | |
| | Whole | | Whole | | Whole | |
| Microflora | surface | Fresh-cut | surface | Fresh-cut | surface | Fresh-cut |
| Aerobic mesophilic bacteria | 3.4 ± 0.2A | 2.1 ± 0.10B | 1.6 ± 0.2C | 0.6 ± 0.02D | 1.3 ± 0.12C | 0.3 ± 0.02D |
| Yeast and mold | 1.3 ± 0.1A | 0.4 ± 0.02B | 0.4 ± 0.05B | BD | 0.5 ± 0.02B | BD |
| Pseudomonas spp. | 1.4 ± 0.3A | 0.7 ± 0.07B | 0.4 ± 0.02B | BD | 0.4 ± 0.06B | BD |
| Lactic acid bacteria | 1.0 ± 0.4A | 0.4 ± 0.02B | 0.8 ± 0.02B | BD | 0.3 ± 0.04B | BD |

^{a}Values represent means ± SD for data from three experiments with duplicate determinations per experiment.
Means in the same row for each class of organism on whole surface or fresh-cut pieces and those after treatments not followed by the same letter are significantly (p <0.05) different
BD = Below detection (<1 CFU/g) [symbol]
indicates data missing or illegible when filed

TABLE 7
Surviving populations of L. monocytogenes, Salmonella spp and Escherichia coli
O157:H7 on cantaloupe, watermelon and honeydew rind surfaces after Lovit, chlorine and
hydrogen peroxide treatments

| | Population (Log₁₀ CFU/cm²)^{a} | | | | | |
|---|---|---|---|---|---|---|
| | Cantaloupe | | | Watermelon | | Hc [symbol] |
| Pathogens | Control | Treated | ELR* | Control | Treated | Control |
| Lovit | | | | | | |
| L. monocytogenes | 3.9 ± 0.10A | 0.4 ± 0.10B | 3.5 | 2.6 ± 0.10B | BD | 2.8 ± 0.10B |
| Salmonella spp. | 4.8 ± 0.02A | 1.5 ± 0.10A | 3.2 | 3.2 ± 0.10B | BD | 2.7 ± 0.10C |
| E. coli O157:H7 | 4.2 ± 0.02A | 0.6 ± 0.10B | 3.5 | 3.0 ± 0.10B | BD | 2.8 ± 0.10C |
| H₂O₂ (3%) | | | | | | |
| L. manocytogenes | 3.9 ± 0.10A | 1.09 ± 0.04B | 2.8 | 2.6 ± 0.10B | 0.42 ± 0.10A | 2.8 ± 0.10B |
| Salmonella spp. | 4.4 ± 0.10A | 1.89 ± 0.04A | 2.5 | 3.2 ± 0.10B | 0.49 ± 0.10A | 2.7 ± 0.10B |
| E. coli O157:H7 | 4.2 ± 0.10A | 1.22 ± 0.04B | 3.0 | 3.0 ± 0.10B | 0.53 ± 0.10A | 2.9 ± 0.10B |
| Chlorine (200 ppm) | | | | | | |
| L. monocytogenes | 3.9 ± 0.10A | 1.2 ± 0.04B | 2.7 | 2.6 ± 0.10B | 0.89 ± 0.10B | 2.8 ± 0.10B |
| Salmonella spp. | 4.4 ± 0.10A | 2.2 ± 0.04A | 2.2 | 3.2 ± 0.10B | 1.19 ± 0.10A | 2.7 ± 0.10B |
| E. coli O157:H7 | 4.2 ± 0.10A | 1.9 ± 0.04A | 2.3 | 3.0 ± 0.10B | 1.03 ± 0.10A | 2.9 ± 0.10B |

^{a}Values represent means ± SD for data from three experiments with duplicate determinations per experiment.
Means for each class of organism in the same column for control or treated melons not followed by the same letter are significantly (p <0.05) different.
BD = Below detection (<3 CFU)
*ELR = Estimated log reduction [symbol]
indicates data missing or illegible when filed

1. A method of producing an antimicrobial solution, said method comprising dissolving nisin in hydrochloric acid and adding an ionic chelator solution to form a base solution, adding sodium lactate to said base solution, followed by adding sorbic acid to said base solution, followed by adding hydrogen peroxide to said base solution, followed by adding citric acid to said base solution, followed by heating said base solution for about 4 hours at a temperature of about 99° C., followed by adjusting the pH of said base solution to about 5.0±0.2 with a base.

2. The method according to claim 1, wherein the container containing said base solution does not allow in light.

3. The method according to claim 1, wherein said method comprises dissolving nisin in hydrochloric acid and adding an ionic chelator solution to form a base solution, heating said base solution for about 5 min, adding sodium lactate to said base solution, followed by adding sorbic acid to said base solution, heating said base solution for about 5 min, followed by adding hydrogen peroxide to said base solution, followed by adding citric acid to said base solution, followed by heating said base solution for about 4 hours at a temperature of about 99° C., followed by adjusting the pH of said base solution to about 5.0±0.2 with a base.

4. The method according to claim 1 wherein said method comprises dissolving nisin in hydrochloric acid and adding an ionic chelator solution to form a base solution, heating said base solution for about 5 min at about 25° C., adding sodium lactate to said base solution, followed by adding sorbic acid to said base solution, heating said base solution for about 5 min at about 62° C., followed by adding hydrogen peroxide to said base solution, followed by adding citric acid to said base solution, followed by heating said base solution for about 4 hours at a temperature of about 99° C., followed by adjusting the pH of said base solution to about 5.0±0.2 with a base.

5. The method according to claim 1, wherein said base is NaOH.

6. The method according to claim 1, wherein said ionic chelator solution is an ethylenediaminetetraacetic acid solution.

7. The method according to claim 1, wherein said ionic chelator solution is a disodium ethylenediaminetetraacetic acid solution.

8. An antimicrobial solution and/or anti-browning solution produced by the method according to claim 1.

9. A method for reducing bacteria on produce and/or minimizing enzymatic browning of produce, said method comprising contacting said produce with an effective bacterial reducing amount and/or an effective enzymatic browning minimizing amount of the antimicrobial solution according to claim 8.

10. Foods treated by a method comprising contacting said foods with an effective bacterial reducing amount and/or an effective enzymatic browning minimizing amount of the antimicrobial solution according to claim 8.

11. The method according to claim 1, said method comprising dissolving nisin in hydrochloric acid and adding an ionic chelator solution to form a base solution, heating said base solution for about 5 min, adding sodium lactate to said base solution, followed by adding sorbic acid to said base solution, heating said base solution for about 5 min, followed by adding hydrogen peroxide to said base solution, followed by adding citric acid to said base solution, followed by heating said base solution for about 4 hours at a temperature of about 99° C., followed by adjusting the pH of said base solution to about 5.0±0.2 with a base.
